(19) United States
(12) Patent Application Publication
(10) Pub. No.: US 2026/0302099 A1
(43) Pub. Date: Oct. 1, 2026

(54) KEYCAP LIFTING MECHANISM AND LONG RECTANGULAR KEYSWITCH STRUCTURE

(71) Applicant: DARFON ELECTRONIC CORP., Taoyuan City (TW)

(72) Inventors: Yu-Yao Shih, Taoyuan City (TW); Hsiao-Han Chu, Taoyuan City (TW); Chin-Hung Lin, Taoyuan City (TW)

(73) Assignee: DARFON ELECTRONIC CORP., Taoyuan City (TW)

(21) Appl. No.: 19/315,631

(22) Filed: Aug. 31, 2025

(30) Foreign Application Priority Data
Mar. 31, 2025 (TW) 114112239

(51) Int. Cl. H01H 13/14; G05G 1/02; G05G 5/05; G06F 3/02; H01H 13/02

(52) U.S. Cl. CPC H01H 13/14; G05G 1/02; G05G 5/05; G06F 3/0202; H01H 13/023; G05G 2505/00

(57) ABSTRACT

A keycap lifting mechanism for supporting a long rectangular keycap includes two supports connected to the long rectangular keycap and pivotally connected to each other around a pivot axis parallel to a long side direction of the long rectangular keycap. One of the supports includes two outer sliding shafts and an inner sliding shaft between, which are slidably and rotatably connected to the long rectangular keycap, and two outer base shafts. In the long side direction, one of the out base shafts is relatively close to one of the outer sliding shaft, and the other outer base shaft is relatively close to the other outer sliding shaft and the inner sliding shaft and is located between them; a distance between the outer base shaft and the outer sliding shaft of the former is less than a distance between the outer base shaft and the outer sliding shaft of the latter.

### BACKGROUND OF THE INVENTION

### 1. Field of the Invention

The present invention relates to a keyswitch structure, and more particularly to a keycap lifting mechanism of a long rectangular keyswitch structure.

### 2. Description of the Prior Art

The keycap lifting mechanism of a general key structure will be connected to every corner of the keycap as much as possible to stably support the keycap and effectively link with the keycap. However, sometimes the keycap lifting mechanism needs to avoid interference with other components and cannot be connected to the corner of the keycap. This affects the stability of the keycap lifting mechanism supporting the keycap and also reduces the efficiency of the linkage between the keycap lifting mechanism and the keycap. Furthermore, with the trend toward miniaturization of key structures, this problem will become worse.

### SUMMARY OF THE INVENTION

In view of the problems in the prior art, an objective of the invention is to provide a keycap lifting mechanism. In a support of the keycap lifting mechanism, an inner sliding shaft is added between two outer sliding shafts to enhance the connection stability between the support and a keycap and the linkage effect therebetween.

A keycap lifting mechanism of an embodiment according to the invention is used for supporting a long rectangular keycap. The long rectangular keycap has a long side direction and a short side direction. The keycap lifting mechanism includes a first support and a second support. The first support has includes a first keycap connection portion and a first base plate connection portion. The second support and the first support are pivotally connected around a pivot axis. The pivot axis is parallel to the long side direction. The second support includes a first outer sliding shaft, a second outer sliding shaft, an inner sliding shaft, a first outer base shaft, and a second outer base shaft. The first outer base shaft is closer to the first outer sliding shaft than the second outer base shaft in the long side direction. The second outer base shaft is closer to the second outer sliding shaft than the first outer base shaft in the long side direction. The inner sliding shaft is located between the first outer sliding shaft and the second outer sliding shaft. The second outer base shaft is located between the second outer sliding shaft and the inner sliding shaft in the long side direction. A distance between the first outer sliding shaft and the first outer base shaft in the long side direction is less than a distance between the second outer sliding shaft and the second outer base shaft in the long side direction. The second outer sliding shaft is closer to the inner sliding shaft than the first outer sliding shaft. Therein, the first support is connected to the long rectangular keycap through the first keycap connection portion. The second support is slidably and rotatably connected to the long rectangular keycap through the first outer sliding shaft, the inner sliding shaft, and the second outer sliding shaft. Thereby, the second support is connected to the long rectangular keycap through the first outer sliding shaft, the second outer sliding shaft, and the inner sliding shaft located therebetween, enhancing the connection stability of the second support and the long rectangular keycap and the linkage effect therebetween.

Another objective of the invention is to provide a long rectangular keyswitch structure, which includes the above keycap lifting mechanism to enhance the connection stability between the keycap lifting mechanism and a keycap and the linkage effect therebetween.

A long rectangular keyswitch structure of an embodiment according to the invention has a long side direction and a short side direction. The long rectangular keyswitch structure includes a base plate, a keycap, and a keycap lifting mechanism. The keycap is disposed above the base plate. The keycap lifting mechanism is connected to the base plate and the keycap. The keycap is vertically movable relative to the base plate through the keycap lifting mechanism. The keycap lifting mechanism includes a first support and a second support. The first support includes a first keycap connection portion and a first base plate connection portion. The first support is connected to the keycap through the first keycap connection portion. The first support is connected to the base plate through the first base plate connection portion. The second support and the first support are pivotally connected around a pivot axis. The pivot axis is parallel to the long side direction. The second support includes a first outer sliding shaft, a second outer sliding shaft, an inner sliding shaft, a first outer base shaft, and a second outer base shaft. The first outer base shaft is closer to the first outer sliding shaft than the second outer base shaft in the long side direction. The second outer base shaft is closer to the second outer sliding shaft than the first outer base shaft in the long side direction. The inner sliding shaft is located between the first outer sliding shaft and the second outer sliding shaft. The second outer base shaft is located between the second outer sliding shaft and the inner sliding shaft in the long side direction. A distance between the first outer sliding shaft and the first outer base shaft in the long side direction is less than a distance between the second outer sliding shaft and the second outer base shaft in the long side direction. The second outer sliding shaft is closer to the inner sliding shaft than the first outer sliding shaft. The second support is slidably and rotatably connected to the keycap through the first outer sliding shaft, the inner sliding shaft, and the second outer sliding shaft. The second support is rotatably connected to the base plate through the first outer base shaft and the second outer base shaft. Similarly, in the keycap lifting mechanism, the second support is connected to the long rectangular keycap through the first outer sliding shaft, the second outer sliding shaft, and the inner sliding shaft located therebetween, thereby enhancing the connection stability of the keycap lifting mechanism and the keycap and the linkage effect therebetween.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a long rectangular keyswitch structure according to an embodiment.

FIG. 2 is a partially-exploded view of the long rectangular keyswitch structure in FIG. 1.

FIG. 3 is a sectional view of the long rectangular keyswitch structure in FIG. 1, of which the position of the cutting plane is shown as the line X-X in FIG. 2.

FIG. 4 is an exploded view of the long rectangular keyswitch structure in FIG. 1.

FIG. 5 is another view of the long rectangular keyswitch structure in FIG. 4 from another viewpoint.

FIG. 6 is a front view of a second support of a keycap lifting mechanism in FIG. 4.

FIG. 7 is a top view of the long rectangular keyswitch structure when a first support and second support of the keycap lifting mechanism are stacked together, in which part of the outline of the keycap is shown in dashed lines.

FIG. 8 is a left side view of the first support and the second support in FIG. 7.

### DETAILED DESCRIPTION

Directional terms mentioned in the following embodiments, such as up, down, left, right, front or back, etc., are only for reference to the directions in the attached drawings. The prefixes of component names, such as first, second, . . . , etc., are only used to distinguish components and facilitate description, and do not impose other restrictions on the components themselves; furthermore, components with the same prefix in various embodiments do not necessarily correspond. The correspondence of components in each embodiment should still depend on the specific structure described in each embodiment.

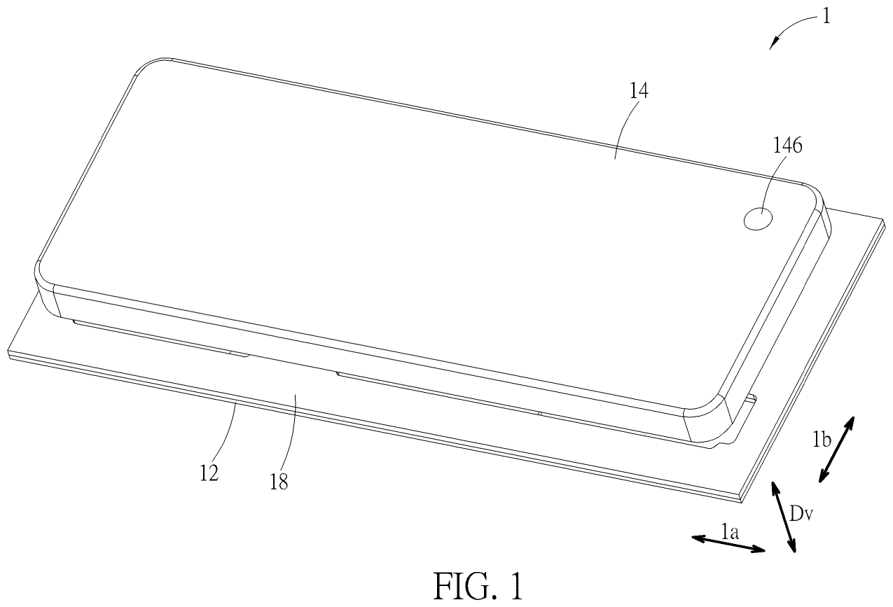

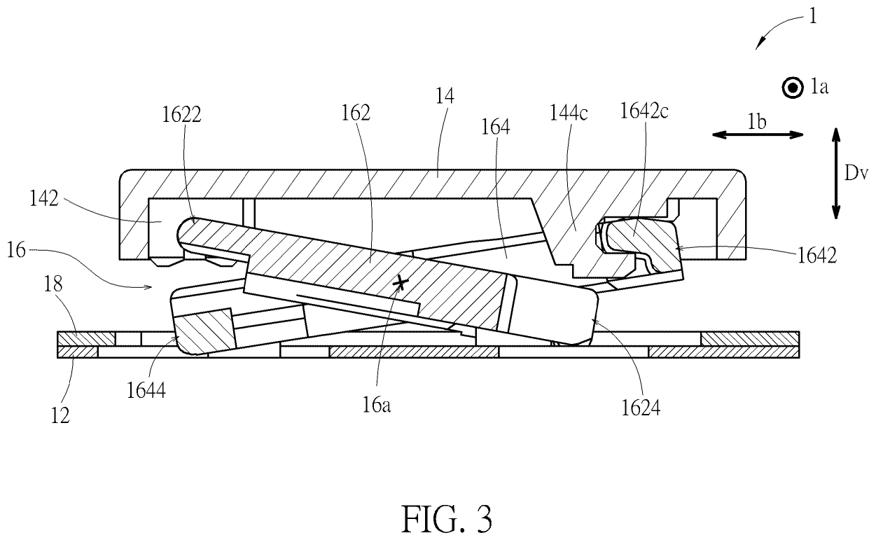

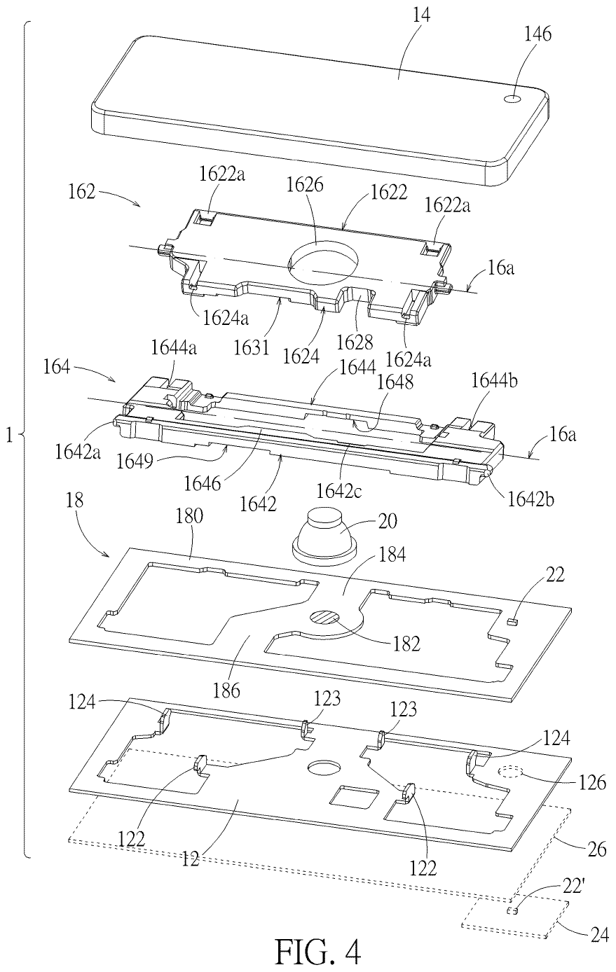

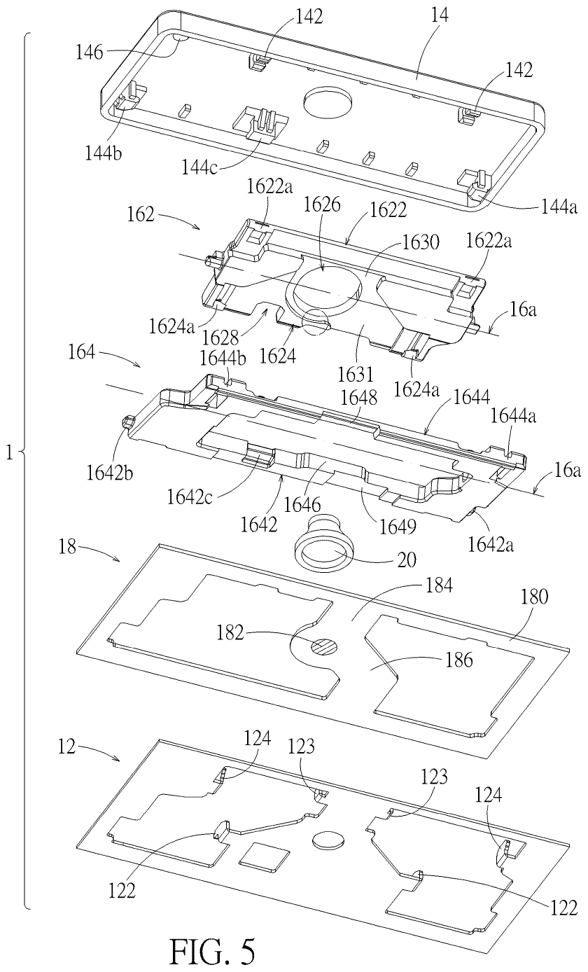

Please refer to FIG. 1 to FIG. 5. A long rectangular keyswitch structure 1 according to an embodiment has a long side direction 1a and a short side direction 1b (both are indicated by double-headed arrows in the figures). The long rectangular keyswitch structure 1 includes a base plate 12, a keycap 14, a keycap lifting mechanism 16, a switch circuit board 18, and an elastic part 20. The keycap 14 is disposed above the base plate 12. The keycap 14 is in the shape of an elongated rectangle, and its long side direction and short side direction are parallel to the long side direction 1a and the short side direction 1b, respectively. The keycap lifting mechanism 16 is connected to and located between the base plate 12 and the keycap 14. The keycap 14 can move up and down relative to the base plate 12 through the keycap lifting mechanism 16, that is, substantially moving along a vertical direction Dv (indicated by a double-headed arrow in the figure and perpendicular to the long side direction 1a and the short side direction 1b). The switch circuit board 18 (for example, but not limited to, implemented by a thin film circuit board, e.g., including upper and lower circuit substrates and an insulating spacer sandwiched therebetween) is stacked on the base plate 12 and has a switch portion 182 (of which the corresponding position on the switch circuit board 18 is indicated by a circle filled with oblique lines in FIG. 4 and FIG. 5). The elastic part 20 (for example, but not limited to, made of rubber) is disposed on the switch circuit board 18 corresponding to the switch portion 182. The keycap 14 can move toward the base plate 12 and press the elastic part 20 to trigger the switch portion 182.

Further, the keycap lifting mechanism 16 includes a first support 162 and a second support 164 which are pivotally connected around a pivot axis 16a (indicated by a chain line in the figures). The pivot axis 16a is parallel to the long side direction 1a. The first support 162 and the second support 164 are respectively connected to and located between the base plate 12 and the keycap 14 to support the keycap 14. Therein, the first support 162 has a first keycap connection portion 1622 and a first base plate connection portion 1624. The first support 162 is connected to the keycap 14 through the first keycap connection portion 1622, and is connected to the base plate 12 through the first base plate connection portion 1624. The first keycap connection portion 1622 includes two holder shafts 1622a. The keycap 14 correspondingly includes two holder hooks 142. Each holder shafts 1622a is rotatably hooked by the corresponding holder hook 142, so that the first support 162 is rotatably connected to (the holder hooks 142 of) the keycap 14 through the holder shafts 1622a. The first base plate connection portion 1624 includes two base shafts 1624a. The base plate 12 correspondingly includes two base hooks 122. Each base shaft 1624a is slidably and rotatably hooked by the corresponding base hook 122, so that the first support 162 is slidably and rotatably connected to (the base hooks 122 of) the base plate 12 through the base shafts 1624a.

The second support 164 has a second keycap connection portion 1642 and a second base plate connection portion 1644. The second support 164 is connected to the keycap 14 through the second keycap connection portion 1642, and is connected to the base plate 12 through the second base plate connection portion 1644. The second keycap connection portion 1642 includes a first outer sliding shaft 1642a, a second outer sliding shaft 1642b, and an inner sliding shaft 1642c. The inner sliding shaft 1642c is located between the first outer sliding shaft 1642a and the second outer sliding shaft 1642b in the long side direction 1a. The keycap 14 correspondingly includes a first outer sliding hook 144a, a second outer sliding hook 144b, and an inner sliding hook 144c. The inner sliding hook 144c is located between the first outer sliding hook 144a and the second outer sliding hook 144b in the long side direction 1a. The first outer sliding shaft 1642a, the second outer sliding shaft 1642b, and the inner sliding shaft 1642c are slidably and rotatably hooked by the first outer sliding hook 144a, the second outer sliding hook 144b and the inner sliding hook 144c, respectively, so that the second support 164 is slidably and rotatably connected to (the first outer sliding hook 144a, the second outer sliding hook 144b, and the inner sliding hook 144c of) the keycap 14 through the first outer sliding shaft 1642a, the second outer sliding shaft 1642b, and the inner sliding shaft 1642c. The second base plate connection portion 1644 includes a first outer base shaft 1644a and a second outer base shaft 1644b. The base plate 12 correspondingly includes two other base hooks 124. The first outer base shaft 1644a and the second outer base shaft 1644b are rotatably hooked by the corresponding base hooks 124, so that the second support 164 is rotatably connected to (the base hooks 124 of) the base plate 12 through the first outer base shaft 1644a and the second outer base shaft 1644b. In addition, the base plate 12 further includes a plurality of stop portions 123. The stop portions 123 limit the second support 164 so that the first outer base shaft 1644a and the second outer base shaft 1644b are kept hooked by the corresponding base hooks 124.

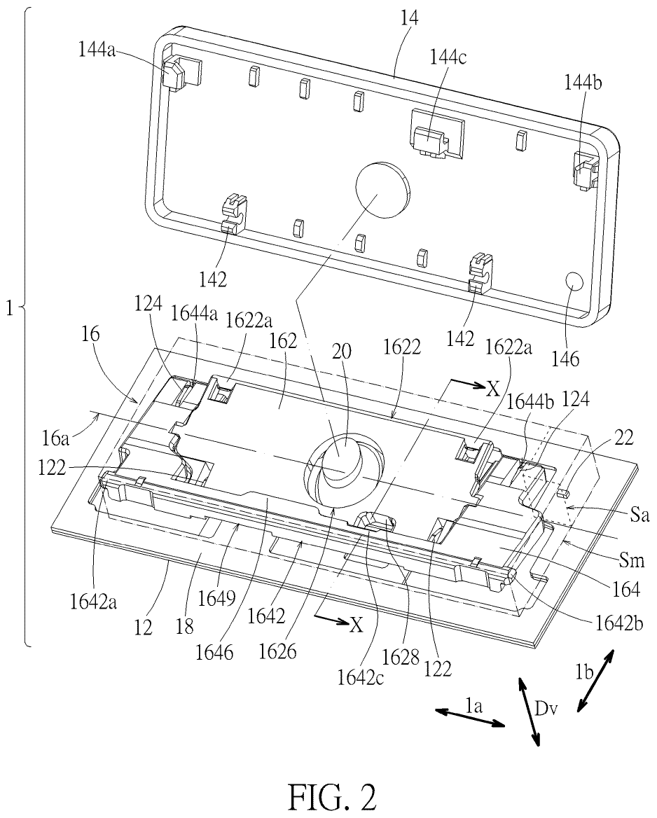

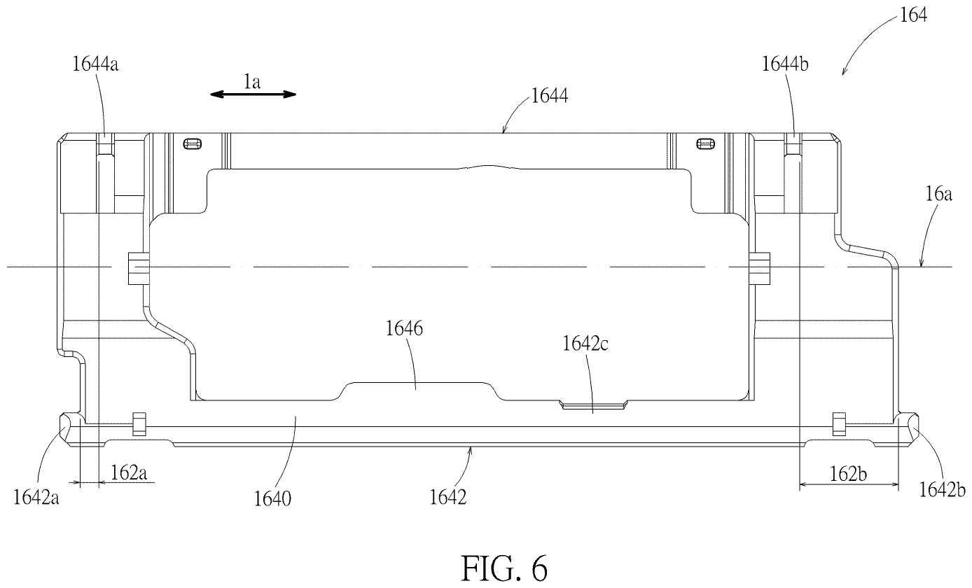

Moreover, in the second support 164 (see also FIG. 6), the second support 164 has an outer frame 1640 (equivalent to a ring frame structure) and is connected to the base plate 12 and the keycap 14 through the outer frame 1640. The first outer base shaft 1644a is closer to the first outer sliding shaft 1642a than the second outer base shaft 1644b in the long side direction 1a. The second outer base shaft 1644b is closer to the second outer sliding shaft 1642b than the first outer base shaft 1644a in the long side direction 1a. The second outer base shaft 1644b is located between the second outer sliding shaft 1642b and the inner sliding shaft 1642c in the long side direction 1a. The second outer sliding shaft 1642b is closer to the inner sliding shaft 1642c than the first outer sliding shaft 1642a. A distance 162a between the first outer sliding shaft 1642a and the first outer base shaft 1644a in the long side direction 1a is less than a distance 162b between the second outer sliding shaft 1642b and the second outer base shaft 1644b in the long side direction 1a. From the viewpoint of FIG. 6, the upper right portion of the second support 164 forms a recessed structure; however, the first outer base shaft 1644a, the second outer base shaft 1644b, the first outer sliding shaft 1642a, and the second outer sliding shaft 1642b are still substantially located at the corners of the second support 164. This recessed structure can prevent the second support 164 from directly shielding light emitted upward by a light-emitting component 22 (shown by a simple block in the figures) disposed on the switch circuit board 18 (see also FIG. 2).

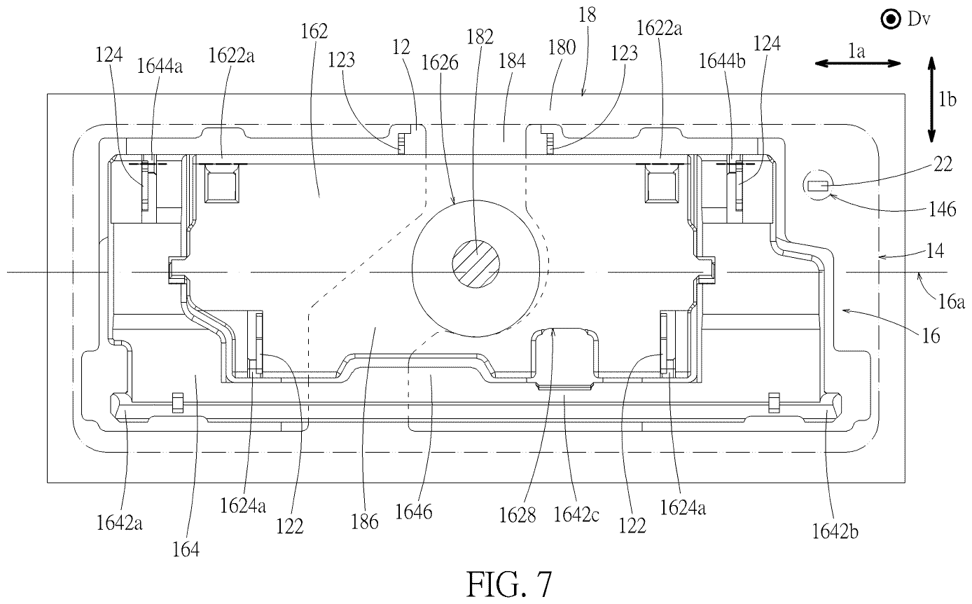

Furthermore, please refer to FIG. 2, FIG. 4 and FIG. 7; therein, in FIG. 7, the outline of the keycap 14 is shown by chain lines, and the elastic part 20 is not shown. In the embodiment, the first support 162 is pivotally connected to the inner side of (the outer frame 1640 of) the second support 164; on the other hand, the second support 164 is pivotally connected to both outer sides of the first support 162 in the long side direction 1a. When the first support 162 and the second support 164 are stacked together (i.e., the first support 162 is stacked on the second support 164), the first support 162 (or its keycap side; the first support 162 is connected to the keycap 14 via this side) overlaps the second support 164 (or its base plate side; the second support 164 is connected to the base plate 12 via this side). Moreover, at this time, projections of the rotation axes (indicated by chain lines in FIG. 7) of the two holder shafts 1622a and projections the rotation axes (indicated by chain lines in FIG. 7) of the first outer base shaft 1644a and the second outer base shaft 1644b in the vertical direction Dv are collinear. On the other hand, at this time, projections of the first outer base shaft 1644a and the second outer base shaft 1644b in the vertical direction Dv (i.e., equivalent to the outline shown in FIG. 7) and projections of the two holder shafts 1622a in the vertical direction Dv (i.e., equivalent to the outline shown in FIG. 7) overlap in the long side direction 1a; in addition, this feature still holds true even when the keycap lifting mechanism 16 supports the keycap 14 up. This structural relationship between the first support 162 and the second support 164 helps to reduce the area occupied by the keycap lifting mechanism 16 in the vertical direction Dv.

Moreover, the first support 162 has a dome hole 1626. The elastic part 20 passes through the dome hole 1626. The inner sliding shaft 1642c is located between the dome hole 1626 and the second outer sliding shaft 1642b in the long side direction 1a. In the embodiment, in the long side direction 1a, except for the inner sliding shaft 1642c, the second support 164 has no other structure connected to the keycap 14 between the second outer sliding shaft 1642b and the dome hole 1626. The connection between the inner sliding shaft 1642c and the inner sliding hook 144c is beneficial to the stability of the connection between the second support 164 and the keycap 14, and can enhance the performance of transmitting the movement of the keycap 14 in the long side direction 1a through the second support 164 (for example, especially the performance of transmitting the movement of the second outer sliding hook 144b of the keycap 14). Moreover, the first support 162 has a notch 1628. The notch 1628 is disposed opposite to the inner sliding shaft 1642c of the second support 164 in the short side direction 1b to avoid interference with the inner sliding hook 144c of the keycap 14. In practice, the portion of the first support 162 at the notch 1628 may be thickened to increase the structural strength of the portion, thereby compensating for the decrease in structural strength that may be caused by the notch 1628 being close to the dome hole 1626. In addition, in the embodiment, the keycap side of the second support 164 further has a protrusion 1646, most of which is located at the left side of the center of the elastic part 20 in the long side direction 1a. This increases the structural strength of the keycap side of the second support 164, improves the stability of the connection between the second support 164 and the keycap 14, and enhances the performance of transmitting the movement of the keycap 14 in the long side direction 1a through the second support 164.

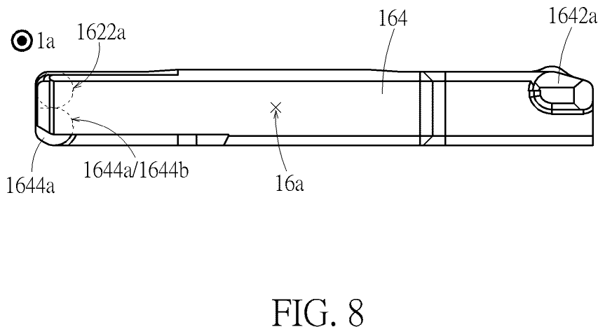

In addition, please refer to FIG. 8, which is a left side view of the first support 162 and the second support 164 in FIG. 7; therein, the hidden outlines of the two holder shafts 1622a, the first outer base shaft 1644a, and the second outer base shaft 1644b are shown in dashed lines. In the embodiment, in the long side direction 1a, the outlines of the two holder shafts 1622a are tangent to the outlines of the first outer base shaft 1644a and the second outer base shaft 1644b. However, it is not limited thereto in practice; for example, the first outer base shaft 1644a and the second outer base shaft 1644b may be designed to be further moved downward so that the two holder shafts 1622a overlap with the first outer base shaft 1644a and the second outer base shaft 1644b in the long side direction 1a.

Please refer to FIG. 2. A minimum rectangular cuboid space Sm (shown in chain lines in the figure) is defined that contains the entire keycap lifting mechanism 16; in other words, during the operation of the keycap lifting mechanism 16, the minimum rectangular cuboid space Sm is the minimum space containing the keycap lifting mechanism 16, that is, the entire keycap lifting mechanism 16 is located within the minimum rectangular cuboid space Sm. All edges of the minimum rectangular cuboid space Sm are parallel to the long side direction 1a, the short side direction 1b, and the vertical direction Dv. An avoidance space Sa (shown in dashed lines in the figure) is defined in the minimum rectangular cuboid space Sm. The avoidance space Sa passes through the minimum rectangular cuboid space Sm in the vertical direction Dv. The keycap lifting mechanism 16 (during the operation) will not enter the avoidance space Sa. Projections of the light-emitting part 22 and the avoidance space Sa in the vertical direction Dv overlap, so that the light emitted upward by the light-emitting part 22 can pass through the avoidance space Sa to illuminate the keycap 14. Furthermore, in the embodiment, the avoidance space Sa is located at a corner of the minimum rectangular cuboid space Sm in the vertical direction Dv (corresponding to the recessed structure of the second support 164); on the other hand, An edge of the avoidance space Sa parallel to the vertical direction Dv coincides with one of the edges of the minimum rectangular cuboid space Sm. Moreover, (see also FIG. 7) a projection of the light-emitting part 22 on the keycap 14 in the vertical direction Dv (equivalent to the position of the light-emitting part 22 relative to the keycap 14 in FIG. 7) is located in a corner area of the keycap 14 (e.g., corresponding to a light-transmitting portion 146 of the keycap 14 for indicating a key function status). In addition, in the embodiment, a length ratio of the edge of the minimum rectangular cuboid space Sm parallel to the long side direction 1a to the edge of the minimum rectangular cuboid space Sm parallel to the short side direction 1b is greater than or equal to 2.5; for example, the length ratio is 2.5 to 3.5. On the other hand, the aspect ratio of the projection of the entire keycap lifting mechanism 16 in the vertical direction Dv is similar to the length ratio. The aspect ratio of the projection of the entire long rectangular keyswitch structure 1 (for example, defined as the space covered by the keycap 14 in the vertical direction Dv) in the vertical direction Dv is also similar to the length ratio. In practice, the long rectangular keyswitch structure 1 can be applied to multiple-length keys on the keyboard, such as Enter key, Shift key, CapsLock key, Ctrl key, Backspace key, etc.

In addition, please refer to FIG. 2 and FIG. 4. In the embodiment, light-emitting part 22 is electrically fixed on the switch circuit board 18; however, it is not limited thereto. For example, the light-emitting component 22′ (shown by a simple block in FIG. 4) is electrically fixed on another circuit board 24 (illustrated as a dashed line in FIG. 4). The circuit board 24 is disposed under the base plate 12. The base plate 12 has a through hole 126 (shown in dashed lines in FIG. 4) formed corresponding to light-emitting component 22′, allowing light emitted upward by the light-emitting component 22′ to pass directly through the base plate 12. For another example, a light-guiding plate 26 (which is shown in dashed lines in FIG. 4, is disposed between the circuit board 24 and the base plate 12, and may has an accommodating recess (not shown in the figure) for accommodating the light-emitting part 22′) is further provided. Light emitted by the light-emitting part 22′ (entering the light-guiding plate 26 through the accommodating recess) is guided by the light-guiding plate 26 to emitted upward out of the light-guiding plate 26, serving as backlight for the long rectangular keyswitch structure 1.

Please refer to FIG. 2 to FIG. 5 and FIG. 7; therein, in FIG. 7, the hidden outline of the switch circuit board 18 is partially shown in dashed lines. The switch circuit board 18 has a peripheral portion 180 extending substantially parallel to the periphery of the keycap 14. The switch circuit board 18 further has a first connection portion 184 and a second connection portion 186 connected to opposite sides of the peripheral portion 180, respectively. The keycap 14 covers the switch portion 182, the first connection portion 184, and the second connection portion 186 in the vertical direction Dv. The switch portion 182 corresponds to a middle portion of the keycap 14. The first connection portion 184 and the second connection portion 186 are connected to two sides of the switch portion 182; therein, the first connection portion 184 extends parallel to short side direction 1b to be connected to the upper side of switch portion 182 (from the viewpoint of in FIG. 7). The second connection portion 186 extends obliquely relative to the long side direction 1a and the short side direction 1b to be connected to the left side of switch portion 182 (from the viewpoint of in FIG. 7). The second connection portion 186 and the inner sliding shaft 1642c are located on the same side of the pivot axis 16a in the short side direction 1b; therein, the portion of the second connection portion 186 connected to the switch portion 182 extends obliquely, and the portion of the second connection portion 186 connected to the peripheral portion 180 extends parallel to the short side direction 1b.

Moreover, the first support 162 has avoidance structures 1630 and 1631 corresponding to the first connection portion 184 and the second connection portion 186. The second support 164 also has avoidance structures 1648 and 1649 corresponding to the first connection portion 184 and the second connection portion 186. The avoidance structures 1630, 1631, 1648 and 1649 are all implemented as groove structures to avoid interference between the first support 162 and the second support 164 with the first connection portion 184 and the second connection portion 186. The structural configuration (offset setting) of the second connection portion 186 makes the avoidance structure 1631 of the first support 162 relatively offset from the narrow area (indicated by a chain line circle in FIG. 5) next to the dome hole 1626, thereby reducing the impact of the avoidance structure 1631 on the structural strength of the first support 162. Similarly, the structural configuration (offset setting) of the second connection portion 186 also makes the avoidance structure 1649 of the second support 164 relatively offset from the inner sliding shaft 1642c and at least partially formed on the protrusion 1646, thereby reducing the impact of the avoidance structure 1649 on the structural strength of the second support 164.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keycap lifting mechanism, used for supporting a long rectangular keycap, the long rectangular keycap having a long side direction and a short side direction, the keycap lifting mechanism comprising:
a first support, the first support comprising a first keycap connection portion and a first base plate connection portion; and
a second support, the second support and the first support being pivotally connected around a pivot axis, the pivot axis being parallel to the long side direction, the second support comprising a first outer sliding shaft, a second outer sliding shaft, an inner sliding shaft, a first outer base shaft, and a second outer base shaft, the first outer base shaft being closer to the first outer sliding shaft than the second outer base shaft in the long side direction, the second outer base shaft being closer to the second outer sliding shaft than the first outer base shaft in the long side direction, the inner sliding shaft being located between the first outer sliding shaft and the second outer sliding shaft, the second outer base shaft being located between the second outer sliding shaft and the inner sliding shaft in the long side direction, a distance between the first outer sliding shaft and the first outer base shaft in the long side direction being less than a distance between the second outer sliding shaft and the second outer base shaft in the long side direction, the second outer sliding shaft being closer to the inner sliding shaft than the first outer sliding shaft;
wherein the first support is connected to the long rectangular keycap through the first keycap connection portion, and the second support is slidably and rotatably connected to the long rectangular keycap through the first outer sliding shaft, the inner sliding shaft, and the second outer sliding shaft.

2. The keycap lifting mechanism according to claim 1, wherein the first support has a dome hole, and the inner sliding shaft is located between the dome hole and the second outer sliding shaft in the long side direction.

3. The keycap lifting mechanism according to claim 2, wherein the first support has a notch, and the notch and the inner sliding shaft are arranged opposite to each other in the short side direction.

4. The keycap lifting mechanism according to claim 2, wherein in the long side direction, except for the inner sliding shaft, the second support has no other structure connected to the long rectangular keycap between the second outer sliding shaft and the dome hole.

5. The keycap lifting mechanism according to claim 1, wherein the second support is pivotally connected to two outer sides of the first support in the long side direction.

6. The keycap lifting mechanism according to claim 5, wherein the second support comprises an outer frame, the first support is pivotally connected to an inner side of the outer frame, and the second support is connected to the long rectangular keycap through the outer frame.

7. The keycap lifting mechanism according to claim 1, wherein the first keycap connection portion comprises two holder shafts, and the first support is rotatably connected to the long rectangular keycap through the two holder shafts.

8. The keycap lifting mechanism according to claim 7, wherein projections of the first outer base shaft and the second outer base shaft in a vertical direction overlap with projections of the two holder shafts in the vertical direction in the long side direction.

9. The keycap lifting mechanism according to claim 7, wherein when the first support and the second support are stacked together, the two holder shafts overlap with the first outer base shaft and the second outer base shaft in the long side direction.

10. The keycap lifting mechanism according to claim 1, wherein a minimum rectangular cuboid space is defined that contains the entire keycap lifting mechanism, all edges of the minimum rectangular cuboid space are parallel to the long side direction, the short side direction, and a vertical direction, the vertical direction is perpendicular to the long side direction and the short side direction, an avoidance space is defined in the minimum rectangular cuboid space, the avoidance space passes through the minimum rectangular cuboid space in the vertical direction, the keycap lifting mechanism does not enter the avoidance space, and an edge of the avoidance space parallel to the vertical direction coincides with one of the edges of the minimum rectangular cuboid space.

11. The keycap lifting mechanism according to claim 10, wherein a length ratio of the edge of the minimum rectangular cuboid space parallel to the long side direction to the edge of the minimum rectangular cuboid space parallel to the short side direction is greater than or equal to 2.5.

12. A long rectangular keyswitch structure, the long rectangular keyswitch structure having a long side direction and a short side direction, the long rectangular keyswitch structure comprising:
a base plate;
a keycap, the keycap being disposed above the base plate; and
a keycap lifting mechanism, the keycap lifting mechanism being connected to the base plate and the keycap, the keycap being vertically movable relative to the base plate through the keycap lifting mechanism, the keycap lifting mechanism comprising:
a first support, the first support comprising a first keycap connection portion and a first base plate connection portion, the first support being connected to the keycap through the first keycap connection portion, the first support being connected to the base plate through the first base plate connection portion; and
a second support, the second support and the first support being pivotally connected around a pivot axis, the pivot axis being parallel to the long side direction, the second support comprising a first outer sliding shaft, a second outer sliding shaft, an inner sliding shaft, a first outer base shaft, and a second outer base shaft, the first outer base shaft being closer to the first outer sliding shaft than the second outer base shaft in the long side direction, the second outer base shaft being closer to the second outer sliding shaft than the first outer base shaft in the long side direction, the inner sliding shaft being located between the first outer sliding shaft and the second outer sliding shaft, the second outer base shaft being located between the second outer sliding shaft and the inner sliding shaft in the long side direction, a distance between the first outer sliding shaft and the first outer base shaft in the long side direction being less than a distance between the second outer sliding shaft and the second outer base shaft in the long side direction, the second outer sliding shaft being closer to the inner sliding shaft than the first outer sliding shaft, the second support being slidably and rotatably connected to the keycap through the first outer sliding shaft, the inner sliding shaft, and the second outer sliding shaft, the second support being rotatably connected to the base plate through the first outer base shaft and the second outer base shaft.

13. The long rectangular keyswitch structure according to claim 12, further comprising a light-emitting part, wherein a minimum rectangular cuboid space is defined that contains the entire keycap lifting mechanism, all edges of the minimum rectangular cuboid space are parallel to the long side direction, the short side direction, and a vertical direction, the vertical direction is perpendicular to the long side direction and the short side direction, an avoidance space is defined in the minimum rectangular cuboid space, the avoidance space passes through the minimum rectangular cuboid space in the vertical direction, the keycap lifting mechanism does not enter the avoidance space, an edge of the avoidance space parallel to the vertical direction coincides with one of the edges of the minimum rectangular cuboid space, and projections of the light-emitting part and the avoidance space in the vertical direction overlap.

14. The long rectangular keyswitch structure according to claim 13, wherein a length ratio of the edge of the minimum rectangular cuboid space parallel to the long side direction to the edge of the minimum rectangular cuboid space parallel to the short side direction is greater than or equal to 2.5.

15. The long rectangular keyswitch structure according to claim 13, wherein a projection of the light-emitting part on the keycap in the vertical direction is located at a corner area of the keycap.

16. The long rectangular keyswitch structure according to claim 12, further comprising a switch circuit board, wherein the switch circuit board is stacked on the base plate, the switch circuit board has a switch portion, a first connection portion, and a second connection portion, the switch portion corresponds to a middle portion of the keycap, the first connection portion and the second connection portion are connected to two sides of the switch portion, the first connection portion extends parallel to the short side direction to be connected to the switch portion, the second connection portion extends obliquely relative to the long side direction and the short side direction to be connected to the switch portion, and the second connection portion and the inner sliding shaft are located on a same side of the pivot axis in the short side direction.

17. The long rectangular keyswitch structure according to claim 12, wherein the first support has a dome hole, and the inner sliding shaft is located between the dome hole and the second outer sliding shaft in the long side direction.

18. The long rectangular keyswitch structure according to claim 17, wherein the first support has a notch, and the notch and the inner sliding shaft are arranged opposite to each other in the short side direction.

19. The long rectangular keyswitch structure according to claim 17, wherein in the long side direction, except for the inner sliding shaft, the second support has no other structure connected to the long rectangular keycap between the second outer sliding shaft and the dome hole.

20. The long rectangular keyswitch structure according to claim 12, wherein the second support is pivotally connected to two outer sides of the first support in the long side direction.

21. The long rectangular keyswitch structure according to claim 20, wherein the second support comprises an outer frame, the first support is pivotally connected to an inner side of the outer frame, and the second support is connected to the long rectangular keycap through the outer frame.

22. The long rectangular keyswitch structure according to claim 12, wherein the first keycap connection portion comprises two holder shafts, and the first support is rotatably connected to the long rectangular keycap through the two holder shafts.

23. The long rectangular keyswitch structure according to claim 22, wherein projections of the first outer base shaft and the second outer base shaft in a vertical direction overlap with projections of the two holder shafts in the vertical direction in the long side direction.

24. The long rectangular keyswitch structure according to claim 22, wherein when the first support and the second support are stacked together, the two holder shafts overlap with the first outer base shaft and the second outer base shaft in the long side direction.
